(19) United States
(12) Patent Application Publication
(10) Pub. No.: US 2005/0065281 A1
(43) Pub. Date: Mar. 24, 2005

(54) Synthetic matrix for controlled cell ingrowth and tissue regeneration

(76) Inventors: Mathias Lutolf, Zurich (CH); Jason C. Schense, Zurich (CH); Anna Jen, Zurich (CH); Jeffrey A. Hubbell, Zurich (CH)

Correspondence Address: PATREA L. PABST;PABST PATENT GROUP LLP, 400 COLONY SQUARE, SUITE 1200, ATLANTA, GA, 30361, US

(21) Appl. No.: 10/494,905

(22) PCT Filed: Nov. 7, 2002
(86) PCT No.: PCT/EP02/12458

(30) Foreign Application Priority Data
Nov. 7, 2001 (US) 60337783

(51) Int. Cl. C08H 1/00

(52) U.S. Cl. 525/54.1

(57) ABSTRACT

Biomaterial comprises a three dimensional polymeric network obtainable from the reaction of at least a first and second precursor molecule. The first precursor molecule is at least a trifunctional, branched component comprising at least three arms substantially similar in molecular weight and the second precursor molecule is at least a bifunctional component The ratio of equivalent weight or the functional groups of the first and second precursor molecule is in a range of between 0.9 and 1.1. The molecular weight of the arms of the first precursor molecule. the molecular weight of the second precursor molecule and the functionality of the branching points are selected so that the water content of the polymeric networks is between the equilibrium weight % and 92 weitht of the total weight of the polymeric network after completion of water uptake. The present invention teaches a way to improve characteristics of synthetic matrices which are useful for wound healing applications.

The use of biomaterials which act as three dimensional scaffolds or matrices (with or without bioactive factors attached) for wound healing applications and tissue regeneration have been described before. For application in the body, in-siu formation of the matrix right at the site of need in the body is often very favorable in comparison to implantation of preformed biomaterials which requires invasive surgery, have difficult sterility issues and often do not match the shape of the defect very well. However the application in the body limits the choice of chemistry both with regard to the crosslinking chemistry as well as with regard to the nature of precursor molecules necessary for the in-situ formation of the matrix With regard to the precursor molecules varying approaches have been employed. One utilizes naturally occurring precursors, another focuses on completely synthetic, e.g. not naturally occurring precursors and in still another approach combinations of naturally occurring and synthetic educts or modifications of one or the other are used.

Matrices based on naturally occurring or chemically modified naturally occurring proteins, like collagen, denatured collagen (gelatin) and in particular fibrin have been tested successfully. In particular good healing responses have been achieved with matrices based on fibrin. Other examples include carbohydrates, like cellulose, alginates and hyaluronic acid. Potential problems such as immunogenicity, expensive production, limited availability, batch variability and purification problems can limit the use of matrices which are formed from naturally occurring precursors.

Due to these concerns matrices based on synthetic precursor molecules have been developed for tissue regeneration in and/or on the body.

Crosslinking reactions for forming synthetic matrices for application in the body include (i) free-radical polymerization between two or more precursors containing unsaturated double bonds, as described in Hern, Hubbell, J. Biomed. Mater. Res. 39:266-276, 1998, (ii) nucleophilic substitution reaction such as eg. between a precursor comprising an amine group and a precursor comprising a succinimidyl group as disclosed in U.S. Pat. No. 5,874,500, (iii) condensation and addition reactions and (iv) Michael type addition reaction between a strong nucleophile and a conjugated unsaturated group or bond (as a strong electrophile), such as the reaction between a precursor molecule comprising thiol or amine groups as nucleophiles and precursor molecules comprising acrylate or vinyl sulfone groups as electrophiles. Michael type addition reactions are described in WO00/44808, the content of which is incorporated herein by reference.Michael type addition reaction allows for in situ crosslinking of at least a first and a second precursor component under physiological conditions in a very self-selective manner, even in the presence of sensitive biological materials. i.e. the first precursor component reacts much faster with a second precursor component than with other components in the sensitive biological environment and the second precursor component reacts much quicker with the first precursor component than with other components in the sensitive biological environment which is present in the body. When one of the precursor component has a functionality of at least two, and at least one of the other precursor component has a functionality greater than two, the system will self-selectively react to form a cross-linked three dimensional biomaterial.

Although progress has been made in recent years to improve the wound healing properties of synthetic matrices, they still do not reach the healing results matrices show which are made from naturally occurring precursor molecules or polymers, in particular fibrin matrices.

It is an object of the present invention to improve the wound healing capacity of synthetic matrices, in particular for defects in bone. In particular synthetic matrices shall be provided which allow application and healing of tissue that are not subject to a natural healing response.

It is a further object to improve the matrix morphology, in particular to improve the matrix properties with regard to cell infiltration.

In still a further object of the present invention the structure and function of the matrix network shall be optimized.

These objects are solved by a biomaterial comprising a three-dimensional polymeric network obtainable from the reaction of at least a first and a second precursor molecule, wherein the first precursor molecule is at least a trifunctional branched polymer comprising at least three arms substantially similar in molecular weight and wherein the second precursor molecule is at least a bifunctional molecule, wherein the ratio of equivalent weight of the functional groups of the first and second precursor molecule is between 0.9 and 1.1, and wherein the molecular weight of the arms of the first precursor molecule, the molecular weight of the second precursor molecule and the functionality of the branching points are selected such that the water content of the polymeric network is between the equilibrium weight % and 92 weight % of the total weight of the polymeric network after completion of water uptake.

For most healing indications the rate of cell ingrowth or migration of cells into matrix in combination with an adapted degradation rate of the matrix is crucial for the overall healing response. The potential of matrices to become invaded by cells is primarily a question of network density, i.e. the space between branching points or nodes. If the existing space is to small in relation to the size of the cells or if the rate of degradation of the matrix, which results in creating more space within the matrix, is too slow, a very limited healing response will be observed. Healing matrices found in nature, as e.g. fibrin matrices, which are formed as a response to injury in the body are known to consist of a very loose network which very easily can be invaded by cells. The infiltration is promoted by ligands for cell adhesion which are an integrated part of the fibrin network.

Other than fibrin matrices, matrices made from synthetic hydrophilic precursor molecules, like polyethene glycol swell in aqueous environment after formation of the polymeric network. In order to achieve a sufficiently short gelling time (between 3 to 10 minutes at a pH of between 7 to 8 and a temperature in a range of 36 to 38° C.) and quantitative reaction during in-situ formation of the matrix in the body, the starting concentration of the precursor molecules must be sufficiently high. Supposed swelling after network formation would not take place, the necessary starting concentrations would lead to matrices too dense for cell infiltration. Thus swelling of the polymeric network is important to enlarge and widen the space between the branching points.

Irrespective of the starting concentration of the precursor molecules, hydrogels made from the same synthetic precursor molecules swell to the same water content in equilibrium state. This means that the higher the starting concentration of the precursor molecules are, the higher the end volume of the hydrogel is when it reaches its equilibrium state. If the space available in the body is too small to allow for sufficient swelling the rate of cell infiltration and as a consequence the healing response will decrease. As a consequence the optimum between two contradictory requirements, for application in the body must be found. On the one hand the starting concentrations must be sufficiently high to guarantee the necessary gelling-time, which on the other hand can lead to matrix which may require too much space for the space available in the defect to achieve the necessary water content and thus remains too dense for cell infiltration. Good cell infiltration and subsequent healing responses have been observed with biomaterials in which the water concentration of the hydrogel is in a range of between the equilibrium water content and 92 weight % of the total weight of the polymeric network and the water after completion of water uptake. Preferably the water content is between 93 and 95 weight % of the total weight of the polymeric network and the water after completion of water uptake. Completion of water uptake can be achieved either because the equilibrium concentration is reached or because the space available does not allow for further volume increase. It is therefore preferred to choose the starting concentrations of the precursor components as low as possible.

The balance between gelling time and low starting concentration has to be optimised by the structure of the precursor molecules. In particular the molecular weight of the arms of the first precursor molecule, the molecular weight of the second precursor molecule and the degree of branching, i.e. the functionality of the branching points have to be adjusted accordingly. The actual reaction mechanism has a minor influence on this interplay.

With an increase in the overall branching degree of the polymeric network the molecular weight of the interlinks, i.e. the length of the links must increase.

Is the first precursor molecule a three or four arm polymer with a functional group at the end of each arm and is the second precursor molecule a linear bifunctional molecule, then the molecular weight of the arms of the first precursor molecule and the molecular weight of the second precursor molecule are preferably chosen such that the links between the branching points after formation of the network have a molecular weight in the range of between 10 to 13 kD (under the conditions that the links are linear, not branched) , preferably between 11 and 12 kD. This allows for a starting concentration of the sum of first and second precursor molecules in a range of between 8 and 12 weight %, preferably between 9 and 10 weight % of the total weight of the fust and second precursor molecule in solution (before network formation). In case the branching degree of the first precursor component is increased to eight and the second precursor molecule is still a linear bifunctional molecule, the molecular weight of the links between the branching points is preferably increased to a molecular weight of between 18 to 24 kD. In case the branching degree of the second precursor molecule is increased from linear to a three or four arm precursor component the molecular weight, i.e. the length of the links increase accordingly.

The first and second precursor molecules are selected from the group consisting of proteins, peptides, polyoxyalkylenes, poly(vinyl alcohol), poly(ethylene-co-vinyl alcohol), poly(acrylic acid), poly(ethylene-co-acrylic acid), poly(ethyloxazoline), poly(vinyl pyrrolidone), poly(ethylene-co-vinyl pyrrolidone), poly(maleic acid), poly(ethylene-co-maleic acid), poly(acrylamide), or poly(ethylene oxide)-co-poly(propylene oxide) block copolymers. Particularly preferred is polyethylen glycol.

Most preferred the first precursor molecule is a polyethylene glycol. The second precursor molecule most preferably is chosen from polyethylene glycol or peptides.

Functionalised polyethylene glycols (PEG) have been shown to combine particularly favourable properties in the formation of synthetic biomaterials. Its high hydrophilicity, low degradability by mammalian enzymes and low toxicity make the molecule particularly useful for application in the body. One can readily purchase or synthesize linear (meaning with two ends) or branched (meaning more than two ends) PEGs and then functionalize the PEG end groups according to the reaction mechanisms of choice.

In a preferred embodiment of the present invention a composition is chosen comprising as the first precursor molecule a trifunctional three arm 15 kD polymer, i.e. each arm having a molecular weight of 5 kD and as the second precursor molecule a bifunctional linear molecule of a molecular weight in the range of between 0.5 to 1.5 kD, even more preferably around 1 kD. Preferably the first and the second precursor component is a polyethylene glycol. Preferably the first precursor component comprises as functional groups conjugated unsaturated groups or bonds, most preferred an acrylate or a vinylsulfone and the functional groups of the second precursor molecule comprises a nucleophilic group, preferably an thiol or amino groups. In another preferred embodiment of the present invention the first precursor molecule is a four arm 20 kD (each arm a molecular weight of 5 kDa) polymer having functional groups at the terminus of each arm and as the second precursor molecule a bifunctional linear molecule of a molecular weight in the range of between 1 to 3 kDa, preferred between 1.5 and 2 kD. Preferably the first precursor molecule is a polyethylene glycol and the second precursor molecule is a peptide. In both preferred embodiments the starting concentration of the sum of first and second precursor molecule ranges from the 8 to 11 weight %, preferably between 9 and 10 weight % of the total weight of the first and second precursor molecule and water (before formation of polymeric network), preferably between 5 and 8 weight % to achieve a gelling time of below 10 minutes. These compositions had a gelling time at pH 8.0 and 37° C. of about 3-10 minutes after mixing. Also in this embodiment preferred functional groups for the first precursor component are conjugated unsaturated groups like acrylates or vinylsulfones and for the second precursor component nucleophilic groups, most preferred thiol groups.

The reaction mechanism for producing the three dimensional network can be chosen among various reaction mechanism such as substitution reactions, free radical reaction and addition reactions.

In case of substitution, condensation and addition reactions one of the precursor molecules comprises nucleophilic groups and the other precursor molecules comprises electrophilic groups, preferably conjugated unsaturated groups or bonds.

In case of free radical reactions both precursor molecules comprise unsaturated bonds, preferably conjugated unsaturated bonds.

Preferably the conjugated unsaturated groups or conjugated unsaturated bonds are selected from the group consisting of acrylates, vinylsulfones, methacrylates, acrylamides, methacrylamides, acrylonitriles, vinylsulfones, 2 or 4-vinylpyridinium, maleimides and quinones.

The nucleophilic groups are preferably selected from the group consisting of thiol-groups, amino-groups and hydroxyl-groups.

A particularly preferred reaction mechanism in the context of the present invention is the Michael type addition reaction between a conjugated unsaturated group or bond and a strong nucleophile as described in WO 00/44808. For Michael type addition reactions the first precursor molecule preferably comprises conjugated unsaturated-groups and in particular a vinylsulfone— or acrylate groups and the second precursor molecule a thiol-group. End-linking of the two precursor components yields a stable three-dimensional network. This Michael-type addition to conjugated unsaturated groups takes place in quantitative yields under physiological conditions without creating any byproducts

The healing rate further depends on matrix susceptibility to cell-secreted proteases such as matrix metalloproteases (MMPs), which allow them to undergo cell-mediated degradation and remodeling. Summarized the healing response of the body to matrices apparently is the better, the more the rates of cell infiltration and matrix degradation are synchronized. The poor performance synthetic matrices show in tissue regeneration is due to a poor correlation between structure of the matrix network and its function.

As already mentioned hereinbefore this speed ratio can be tailored by
the structure (i.e. the chain length and number of arms) of the precursor polymer for cell infiltration
the affinity and concentration of adhesion ligands covalently bound to the network to increase cell infiltration
   in the case of enzymatically degradable gels the specificity of the protease substrate to degradation by a desired protease secreted by cells and the enzymatic activity (Km/kcat) or kinetics of enzymatic hydrolysis of the employed protease substrate
in the case of hydrolytically degradable gels the susceptibilty of the matrix to pysiological conditions.
and also: addition of molecules that upregulate the expression and secretion of matrix metalloproteases MMPs (e.g. growth factors) or downregulate or inhibit (e.g. inhibitors) it.

The fine tuning of these factors are largely independent of the crosslinking chemistry used.

Definitions:

By “biomaterial” is meant a material intended to interface with biological systems to evaluate, treat, augment, or replace any tissue, organ or function of the body depending on the material either permanent or temporarily. In the context of the present invention the term “biomaterial” and “matrix” are used synonymously and shall mean an crosslinked polymeric network swollen with water but not dissolved in water, i.e. a hydrogel which stays in the body for a certain period of time fulfilling certain support functions for traumatized or defect soft and hard tissue.

By “strong nucleophile” is meant a molecule which is capable of donating an electron pair to an electrophile in a polar-bond forming reaction. Preferably the strong nucleophile is more nucleophilic than H₂O at physiologic pH. Examples of strong nucleophiles are thiols and amines.

By “conjugated unsaturated bond” is meant the alternation of carbon-carbon, carbon-heteroatom or heteroatom-heteroatom multiple bonds with single bonds, or the linking of a functional group to a macromolecule, such as a synthetic polymer or a protein. Such bonds can undergo addition reactions.

By “conjugated unsaturated group” is meant a molecule or a region of a molecule, containing an alternation of carbon-carbon, carbon-heteroatom or heteroatom-heteroatom multiple bonds with single bonds, which has a multiple bond which can undergo addition reactions. Examples of conjugated unsaturated groups include, but are not limited to vinyl sulfones, acrylates, acrylamides, quinones, and vinylpyridiniums, for example, 2- or 4-vinylpyridinium and itaconates.

By “synthetic precursor molecules” is meant molecules which do nor exist in nature.

By naturally occuring precursor components or polymers” is meant molecules which could be found in nature.

By “functionalize” is meant to modify in a manner that results in the attachment of a functional group or moiety. For example, a molecule may be functionalized by the introduction of a molecule which makes the molecule a strong nucleophile or a conjugated unsaturation. Preferably a molecule, for example PEG, is functionalized to become a thiol, amine, acrylate, or quinone.

Proteins in particular may also be effectively functionalized by partial or complete reduction of disulfide bonds to create free thiols.

By “functionality” is meant the number of reactive sites on a molecule.

By “functionality of the branching points” it is meant the number of arms extending from one point in the molecule.

By “adhesion site” is meant a peptide sequence to which a molecule, for example, an adhesion-promoting receptor on the surface of a cell, binds. Examples of adhesions sites include, but are not limited to, the RGD sequence from fibronectin, and the YIGSR sequence from laminin. Preferably adhesion sites are incorporated into the biomaterial of the present invention.

By “growth factor binding site” is meant a peptide sequence to which a growth factor, or a molecule(s) which binds a growth factor binds. For example, the growth factor binding site may include a heparin binding site. This site will bind heparin, which will in turn, bind heparin-binding growth factors, for example, bFGF, VEGF, BMP, or TGFβ.

By “protease binding site” is meant a peptide sequence which is a substrate for an enzyme.

By “biological activity” is meant functional events mediated by a protein of interest In some embodiments, this includes events assayed by measuring the interactions of a polypeptide with another polypeptide. It also includes assaying the effect which the protein of interest has on cell growth, differentiation, death, migration, adhesion, interactions with other proteins, enzymatic activity, protein phosphorylation or dephosphorylation, transcription, or translation.

By “sensitive biological molecule” is meant a molecule that is found in a cell, or in a body, or which can be used as a therapeutic for a cell or a body, which may react with other molecules in its presence. Examples of sensitive biological molecules include, but are not limited to, peptides, proteins, nucleic acids, and drugs. In the present invention biomaterials can be made in the presence of sensitive biological materials, without adversely affecting the sensitive biological materials.

As used herein, by “regenerate” is meant to grow back a portion, or all of, a tissue. For example, the present invention features methods of regenerating bone following trauma, tumor removal, or spinal fusion, or for regenerating skin to aid in the healing of diabetic foot ulcers, pressure sores, and venous insufficiency. Other tissues which may be regenerated include, but are not limited to, nerve, blood vessel, and cartilage tissue.

“Multifunctional” means more than one electrophilic and/or nucleophilic functional group per molecule (i.e. monomer, oligo-and polymer).

“Self selective reaction” means that the first precursor component of the composition reacts much faster with the second precursor component of the composition and vice versa than with other compounds present both in the mixture or at the site of the reaction. As used herein, the nucleophile preferentially binds to a electrophile, rather than to other biological compounds, and an electrophile preferentially binds to a strong nucleophile rather than to other biological compounds.

“Cross-linking” means the formation of covalent linkages between a nucleophilic and an electrophilic group which belong to at least precursor components to cause an increase in molecular weight.

“Polymeric network” means the product of a process in which substantially all of the monomers, oligo— or polymers are bound by intermolecular covalent linkages through their available functional groups to result in one huge molecule.

“Physiological” means conditions as they can be found in living vertebrates. In particular, physiological conditions refer to the conditions in the human body such as temperature, pH, etc. Physiological temperatures means in particular a temperature range of between 35° C. to 42° C. preferably around 37° C.

“Crosslink density” is defined as the average molecular weight between two crosslinks (M) of the respective molecules.

“Equivalent weight” is defined as mmol of functional group/g of substance.

“Swelling” means the increase in volume and mass by uptake of water by the biomaterial. The terms “water-uptake” and “swelling” are used synonymously throughout this application.

“Equilibrium state” is defined as the state in which a hydrogel undergoes nomass increase or loss when stored under konstant conditions in water.

The synthetic biomaterial can be designed so as to incorporate many of the aspects of the natural system. Peptides that induce cell adhesion through specific receptor-ligand binding and components that enable the matrix to undergo cell-triggered remodeling by matrix metalloproteinases (MMP) were incorporated. MMP substrates were chosen, because—as major proteins in mammalian tissues—their degradation plays a key role in natural ECM turnover (eg. during wound healing) and also in the conduction of tissue regeneration. Other enzyme classes may also be targeted by incorporation of a substrate that is specific for the particular enzymes that is desired. These hydrogels is that the mechanism and speed at which cell migrate in three dimensions both in vitro in vivo can be readily controlled by the characteristics and composition of the matrix independent of addition of any free or matrix-associated exogenous signaling molecules such as growth factors or cytolines.

In the formation of enzymatically degradable matrices, especially matrices peptides provide a very convenient building block. It is straightforward to synthesize peptides that contain two or more cysteine residues, and this component can then readily serve as second precursor molecule comprising nucleophilic groups. For example, a peptide with two free cysteine residues will readily form a hydrogel when mixed with a three arm 15 to 20 k PEG triacrylate at physiological or slightly higher pH (e.g., 8 to 9; the gelation will also proceed well at even higher pH, but at the potential expense of self-selectivity). All bases can be used however preferably a tertiary amine is applied. Triethanolamine is the most preferred. When the first and second liquid precursor molecules are mixed together, they react over a period of a few minutes to form an elastic gel, consisting of a network of PEG chains, bearing the nodes of the network, with the peptides as connecting links. The peptides can be selected as protease substrates, so as to make the network capable of being infiltrated and degraded by cells, much as they would do in a protein-based network. The gelation is self-selective, meaning the peptide reacts mostly with the PEG component and no other components, and the PEG component reacts mostly with the peptide and no other components. In still another embodiment biofunctional agents can be incorporated to provide chemical bonding to other species (eg., a tissue surface).

In a further preferred embodiment peptide sites for cell adhesion are incorporated into the matrix, namely peptides that bind to adhesion-promoting receptors on the surfaces of cells into the biomaterials of the present invention. Such adhesion promoting peptides are selected from the group consisting of the RGD sequence from fibronectin, the YIGSR sequence from laminin. As above, this can be done, for example, simply by mixing a cysteine-containing peptide with the precursor molecule comprising the conjugated unsaturated group, such as PEG diacrylate or triacrylate, PEG diacrylamide or triacrylamide or PEG diquinone or triquinone a few minutes before mixing with the remainder of the precursor component comprising the nucleophilic group, such as tiol-containing precursor component. During this first step, the adhesion-promoting peptide will become incorporated into one end of the precursor multiply functionalized with a conjugated unsaturation; when the remaining multithiol is added to the system, a cross-linked network will form. Another important implication of the way that networks are prepared here, is the efficiency of incorporation of pendant bioactive ligands such as adhesion signals. By any means this step has to be quantitative, since for example unbound ligands (eg. adhesion sites) could inhibit the interaction of cells with the matrix. As described later on, the derivatization of the precursor with such pendant oligopeptides is conducted in a first step in stoichiometric large excess (minimum: 40 fold) of multiarmed electrophilic precursors over thiols and is therefore definitely quantitative. Above from preventing unwanted inhibition, this accomplishment is biologically even more significant: cell behavior is extremely sensitive to small changes in ligand densities and a precise knowledge of incorporated ligands helps to design and understand cell-matrix interactions. Summarized, the concentration of adhesion sites covalently bound into the matrix significantly influences the rate of cell infiltration. For example for a given hydrogel a RGD concentration range can be incorporated into the matrix with supports cell ingrowth and cell migration in an optimal way. The optimal concentration range of adhesion sites like RGD is between 0.04 and 0.05 mM and even more preferably 0.05 mM for a matrix having a water content between equilibrium concentration and 92 weight % after termination of water uptake.

In a further preferred embodiment of the present invention growth factors or growth factor like peptides are covalently attached to the matrix. For bone healing indications members of the TGF β, BMPs, IGFs, PDGFs, in particular BMP 2, BMP 7, TGF β, TGF β3, IGF 1, PDGF AB, human growth releasing factor, PTH 1-84, PTH 1-34 and PTH 1-25 are employed. Unexpectedly, PTH (PTH 1-84, PTH 1-34 and PTH 1-25) showed particularly good bone formation when covalently bound to a synthetic matrix. Best results are achieved by covalently binding PTH 1-34 (amino acid sequence SVSEIQLMHNLGKHLNSMERV EWLRKKLQDVHNF) to a synthetic matrix capable of being infiltarated by cells and afterwards degraded. The growth factors or growth factor like peptides are expressed or chemically synthesized with at least one additional cystein goup (—SH) either directly attached to the protein or peptide or through a linker sequence. The linker sequence can additionally comprise an enzymatically degradable amino acid sequence, so that the growth factor can be cleaved of from the matrix by enzymes in substantially the native form. In the case of PTH 1-34 the bondage to a synthetic matrix for PTH 1-34 is made possible by attaching an additional amino acid sequence to the N-terminus of PTH 134 that contains at least one cysteine. The thiol group of the cysteine can react with a conjugated unsaturated bond on the synthetic polymer to form a covalent linkage. Possibility (a) only a cystein is attached to the peptide, in possibility (b) a enzymatically degradable, in particular a plasmin degradable sequence is attached as linker between the cysteine and the peptide such as CGYKNR. The sequence GYKNR makes the linkage plasmin degradable.

In terms of bone healing growth factors and growth factor like peptides promote bone formation. However it could be shown, that by choosing the right matrix, bone formation could be observed even without growth factors or growth factor like proteins attached to it A matrix obtained from a four arm 20 kD polyethylenglycol having end terminated conjugated unsaturated bonds and a linear polyethyleneglykol having thiol groups at the terminus with a starting concentration of 7.5 weight % of the total weight of both reactants plus water before swelling and cell adhesion peptides in a concentration of between resulted in 40% calcified tissue.

The matrix further can contain additives, like fillers, X-ray contrast agents, thixotropic agents, etc.

In the design of hydrogels as matrices for wound healing applications several factors including e.g. concentration of adhesion peptides, density, kinetic degradability of peptides comprising protease sequences all have an influence in a functional formulation. From this information matrices can be designed for specific healing applications. This is crucial because the ideal formulation for one application will not prove to be the ideal formulation for all other applications.

For bone excellent healing results can be achieved by keeping the rate of cell migration and the rate of matrix degradation at fast. For boney defects a four arm polyethyleneglycol with a molecular weight of about 20 000 D crosslinked with a protease degradation site GCRPQGIWGQDRC and 0,050 mM GRGDSP gave particularly good healing result with a starting concentration of PEG and peptide below 10 weight % of the total weight of the molecules and water (before swelling). The gels have a useable consistency and allow the osteoblasts and precursor cell to easily infiltrate the matrix.

Mixing and Application Mode

It is to be avoided that the precursor molecules are combined or come into contact with each other under conditions that allow polymerization of said molecules prior to application of the mixture to the body. In the overall sense this is achieved by a system comprising at least a first and a second precursor molecule separated from each other wherein at least the first and the second precursor molecule form a three dimensional network upon mixing under conditions that allow polymerization of said precursor molecules. The first and second precursor molecules are preferably stored under exclusion of oxygen and light and at low temperatures, e.g. around +4° C., to avoid decomposition of the functional groups prior to use. Preferably the content of functional groups of each precursor component is measured immediately prior to use and the ratio of first and second precursor component (and other precursor component when appropriate) is adjusted according to the predetermined equivalent weight ratio of the functional groups. The first and the second precursor molecules can be dissolved in the base solution. Or the precursor components and base solution can be stored separately in bipartite syringes which have two chambers separated by an adjustable partition rectangular to the syringe body wall. One of the chambers can contain the precursor component in solid pulverized form, the other chamber contains an appropriate amount of base solution. If pressure is applied to one end of the syringe body, the partition moves and releases bulges in the syringe wall in order that the buffer can float into the chamber containing the corresponding precursor molecule which upon contact with the base solution is dissolved. A bipartite syringe body is used for storage and dissolution of the other precursor molecule in the same way. If both precursor components are dissolved, both bipartite syringe bodies are attached to the two way connecting device and the contents are mixed by squeezing them through the injection needle attached to the connecting device. The connecting device additionally can comprise a static mixer to improve mixing of the contents.

First, a precursor solution with bioactive peptides, for example binders to adhesion-promoting receptors on the cell surface flanked by a single cysteine and/or growth factors or growth factor like peptides, are reacted with the precursor component comprising conjugated unsaturated bonds, in particular with the first precursor component, such as a multiarm PEG precursor. In the second step, a hydrogel is formed upon mixing of e.g. this modified PEG precursor solution with a dithiol-peptide that contains the protease substrate (or any other entity containing at least two nuclephiles). As shown previously, it is self-selective, i.e. acrylates react with thiols much faster than with amines (often present in biological systems, e.g. epsilon amine side chains on lysine). And thiols react faster with vinyl sulfones than with acrylates. Moreover, very few extracellular proteins contain free thiols and 1,4-conjugated unsaturations are rarely found in biological environments allowing gels to be formed in situ and directly in a surgical site in the presence of other proteins, cells and tissues.

Further part of the present invention is a method for preparing a pharmaceutical composition for use in healing applications comprising the steps of
a) providing at least one first trifunctional three arm precursor molecule preferably comprising conjugated unsaturated groups;
b) providing at least one second bifunctional precursor molecule preferably comprising at nucleophilic groups capable of forming covalent linkage with the conjugated unsaturated groups of step a) under physiological conditions;
c) dissolving the first precursor molecule in a base solution;
d) dissolving the second precursor molecule in a base solution;
e) optionally mixing additives like thixotropic agents or fillers in either the solution obtained under step c or d
f) filling the solution obtained in step c) in a delivery device, preferably in a syringe;
g) filling the mixture obtained in step d) in a delivery device, preferably in a syringe.

The starting concentration of the first and second precursor component is in a range of 8 to 11 weight %, preferably between 9 and 10 weight % of the total weight of the first and second precursor molecule and water (before formation of polymeric network). The first and second precursor components, the filler and bases are selected from those described hereinbefore. All components are sterilized prior to mixing. This preferably is done by sterilfiltration of the precursor molecules and gamma irradiation of the fillers. The mixtures as obtained in step f) and g) can be stored over a prolonged time, preferably at low temperatures.

Immediately prior to application the contents of the delivery devices obtained in step f) and g) are mixed with one another. The syringes can be interconnected by a two way connector device and the contents of the syringes are mixed by being squeezed through a static mixture at the outlet of the two way connector device. The mixed components are injected directly at the site of need in the body by connecting the static mixer to the injection needle or the mixture is squeezed in a further syringe which then is connected to the injection needle.

Further part of the present invention is a kit of parts comprising the first and second precursor molecules and the base solution, wherein the sum of the first and second precursor molecule are in a range of between 8 to 12 weight % and preferably 9 to 10 weight % of the total weight of the first and second precursor molecule and the base solution present in the kit.

Further part of the present invention is the use of a composition comprising a first and second precursor molecules and the base solution, wherein the sum of the first and second precursor molecule are in a range of between 8 to 12 weight % and preferably 9 to 10 weight % of the total weight of the first and second precursor molecule and the base solution present for the manufacture of a matrix for wound healing purposes.

### DESCRIPTION OF THE DRAWINGS

FIG. 1 shows the rheological measurements of hydrogels made by PEG molecules with different structure (i.e. molecular weight and number of arms) and an MMP-sensitive dithiol peptide. PEG structure (i.e. m.w. and number of arms) directly correlates with viscoelastic characteristics of the networks. By changing the chain length and number of arms of the molecule at constant precursor concentration (e.g. 10% w/w), the elastic modulus G′ increased with a decrease of the arm length or an increase in functionality of the crosslinking sites-. The correlation between precursor parameters and network properties can be attributed to the well-characterized microstructure of the hydrogels.

FIG. 2 shows the swelling measurements of hydrogels made by PEG molecules with different structure (i.e. molecular weight and number of arms) and an MMP-sensitive dithiol peptide. Swelling ratio directly correlated with the network architecture. The swelling ratio increased with a decrease of the arm length or an increase in functionality of the crosslinking sites.

FIG. 3 shows the MMP-degradability and its sensitivity to the enzymatic activity of the incorporated oligopeptides. Degradation kinetic assessed by swelling, i.e. weight change of hydrogels containing MMP-substrates with different activity responded to the amino acid sequence of the protease substrate peptide (i.e. the enzymatic activity).

FIG. 4 shows the result of the measurement of cellular invasion within hydrogels that contain peptides with different MMP activity. Cellular invasion into hydrogels containing MMP-substrates responds to the enzymatic activity of the latter.

FIG. 5 shows the results of the measurement of cellular invasion within hydrogels that contain various densities of adhesion ligands. Invasion rate is mediated by the density of incorporated RGD sites in a biphasic manner.

FIG. 6 shows the result of the measurement of cellular invasion within MMP-sensitive and adhesive hydrogels that contain various molecular weights of precursor molecules. Cell invasion into synthetic gels increases with molecular weight. A threshold molecular weight (4armPEG10 kD) was found below which cell invasion ceased.

FIG. 7 show the result of the measurement of cellular invasion within hydrogels that are MMP-sensitive and very loosely cross-linked (i.e. contain a large amount of defects) (7A) or are not degradable by cell-derived MMPs (7B). Cell invasion rates can be increased by loosening up the network structure, for example by introducing defects in the gel. Non-proteolytic cell invasion occurs within hydrogels with a very loosely X-linked network. In this example a high degree of defects (Q larger than ca. 10) was necessary. Cell morphology is different from the one in proteolytically degradable matrices. Cells are very thin and spindle-shaped and migrate almost completely straight and radially out of the cluster. Thus, the mechanism of cellular infiltration can be switched from a predominantly proteolytic to a non-proteolytic one.

FIG. 8 shows the healing results at 3-5 weeks in the critical size rat cranial defect. 8 mm defects were created in the rat cranium and then prepolymerized gels with 5 μg/mL of rhBMP-2 were placed into the defects. Gels containing a non-MMP-sensitive PEG-(SH)2 (A) and MMP substrates with two different enzymatic activity were tested, including the fast degrading substrate, Ac-GCRDGPQGIWGQDRCG, (B) and the slower degrading oligopeptide Ac-GCRDGPQGIWGQDRCG (C). The animals were sacrificed at the endpoint and then the results were analyzed with radiographs and histology. The healing response was dependend on the enzymatic activiy of the incorporated substrate. Nondegradable gels didn't show any cell infiltration (A) and a layer of bone surrounding the implant was formed. The slower degrading gel (B) showed more cell infiltration and the matrix was partially remodelled, whereas the fastest degrading gel (C) showed newly formed bone and very little remaining matrix with morphology similar to original bone. Here, complete bridging of the defects was observed.

FIG. 9 shows the healing results at 3-5 weeks in the critical size rat cranial defect. 8 mm defects were created in the rat cranium and then prepolymerized gels with 5 μg/mL of rhBMP-2 were placed into the defects. Gels with different structure were tested, including collagenase degradeable gels made with 4arm15K peg VS (A), collagenase degradeable gels made with 4arm20K peg VS (B) and hydrolytically degradable gels made with 3.4Kpegdithiol and 4arm15K PEG acrylate (C). The animals were sacrificed at the endpoint and then the results were analyzed with radiographs and histology. In each animal we saw complete bridging of the defects at this early timepoint but distinct morphology differences. The slower degrading gel (A) showed less cell infiltration and more remaining matrix while the fastest degrading gel (C) showed newly formed bone with morphology similar to original bone.

FIG. 10 shows the healing results at 8 weeks in the 8 mm sheep drill defect. Five different synthetic matrices with different structure and enzymatic degradability were tested for their healing response by adding 20 μg/mL of rhBMP-2. The gels were ordered by increased cell infiltration capability with SRT1 having the lowest cell infiltration and SRT5 having the highest. It can be seen that the healing response correlates extremely well with the ability for cells to infiltrate the matrix with the most responsive matrices providing the highest healing potential.

### EXAMPLES

### Example 1

### Preparation of Basic Reagents

Preparation of PEG-Vinylsulfones

Commercially available branched PEGs (4arm PEG, mol. wt. 14,800, 4 arm PEG, mol. wt. 10,000 and 8arm PEG, mol. wt. 20,000; Shearwater Polymers, Huntsville, Ala., USA) were functionalized at the OH-termini.

PEG vinyl sulfones were produced under argon atmosphere by reacting a dichloromethane solution of the precursor polymers (previously dried over molecular sieves) with NaH and then, after hydrogen evolution, with divinylsulfone (molar ratios: OH 1: NaH 5: divinylsulfone 50). The reaction was carried out at room temperature for 3 days under argon with constant stirring. After the neutralization of the reaction solution with concentrated acetic acid, the solution was filtered through paper until clear. The derivatized polymer was isolated by precipitation in ice cold diethylether. The product was redissolved in dichloromethane and reprecipitated in diethylether (with thoroughly washing) two times to remove all excess divinylsulfone. Finally the product was dried under vacuum. The derivatization was confirmed with ¹H NMR. The product showed characteristic vinyl sulfone peaks at 6.21 ppm (two hydrogens) and 6.97 ppm (one hydrogen). The degree of end group conversion was found to be 100%.

Preparation of PEG-Acrylates

PEG acrylates were produced under argon atmosphere by reacting an azeotropically dried toluene solution of the precursor polymers with acryloyl chloride, in presence of triethylamine (molar ratios: OH 1: acryloyl chloride 2: triethylamine 2.2). The reaction proceeded with stirring overnight in the dark at room temperature. The resulting pale yellow solution was filtered through a neutral alumina bed; after evaporation of the solvent, the reaction product was dissolved in dichloromethane, washed with water, dried over sodium sulphate and precipitated in cold diethyl ether. Yield: 88%; conversion of OH to acrylate: 100% (from ¹H-NMR analysis)

¹H-NMR (CDCl₃): 3.6 (341H (14800 4arm: 337H theor.), 230 (10000 4arm: 227H theor.), or 210H (20000 8arm: 227H theor.), PEG chain protons), 4.3 (t, 2H, —CH₂—CH₂—O—CO—CH═CH₂), 5.8 (dd, 1H, CH₂—CH—COO—), 6.1 and 6.4 (dd, 1H, CH₂═CH—COO—) ppm. FR-IR (film on ATR plate): 2990-2790 (υ C—H), 1724 (υ C═O), 1460 (ν [symbol] CH₂), 1344, 1281, 1242, 1097 (υ [symbol] , C—O—C), 952, 842 (υ [symbol] C—O—C) cm⁻¹.

Peptide Synthesis

All peptides were synthesized on solid resin using an automated peptide synthesizer (9050 Pep Plus Synthesizer, Millipore, Framingham, USA) with standard 9-fluorenylmethyloxycarbonyl chemistry. Hydrophobic scavengers and cleaved protecting groups were removed by precipitation of the peptide in cold diethyl ether and dissolution in deionized water. After lyophilization, the peptides were redissolved in 0.03 M Tris-buffered saline (TBS, pH 7:0) and purified using HPLC (Waters; Milford, USA) on a size exclusion column with TBS, pH 7.0 as the running buffer.

### Example 2

### Hydrogel Formation by Conjugate Addition Reactions

MMP-Sensitive Gels Forned by Conjugate Addition with a Peptide-Linked Nucleophile and a PEG-Linked Conjugated Unsaturation that Allow Proteolytic Cell Migration

The synthesis of gels is accomplished entirely through Michael-type addition reaction of thiol-PEG onto vinylsulfone-functionalized PEG. In a first step, adhesion peptides were attached pendantly (e.g. the pep tide Ac-GCGYGRGDSPG-NH₂) to a multiarmed PEG-vinylsulfone and then this precursor was cross-linked with a dithiol-containing peptide (e.g. the MMP substrate Ac-GCRDGPQGIAGFDRCG-NH₂). In a typical gel preparation for 3-dimensional in vitro studies, 4arm-PEG-vinylsulfone (mol. wt. 15000) was dissolved in a TEOA buffer (0.3M, pH 8.0) to give a 10% (w/w) solution. In order to render gels cell-adhesive, the dissolved peptide Ac-GCGYGRGDSPG-NH₂ (same buffer) were added to this solution. The adhesion peptide was allowed to react for 30 minutes at 37° C. Afterwards, the crosslinker peptide Ac-GCRDGPQGIWGQDRCG-NH₂ was mixed with the above solution and gels were synthesized. The gelation occured within a few minutes, however, the crosslinking reaction was carried out for one hour at 37° C. to guarantee complete reaction.

MMP-Non-Sensitive Gels Formed by Conjugate Addition with a PEG-Linked Nucleophile and a PEG-Linked Conjugated Unsaturation that Allow Non-Proteolytic Cell Migration

The synthesis of gels is also accomplished entirely through Michael-type addition reaction of thiol-PEG onto vinylsulfone-functionalized PEG. In a first step, adhesion peptides were attached pendantly (e.g. the peptide Ac-GCGYGRGDSPG-NH₂) to a multiarmed PEG-vinylsulfone and then this precursor was crosslinked with a PEG-dithiol (m.w.3.4 kD). In a typical gel preparation for 3-dimensional in vitro studies, 4arm-PEG-vinylsulfone (mol. wt. 15000) was dissolved in a TEOA buffer (0.3M, pH 8.0) to give a 10% (w/w) solution. In order to render gels cell-adhesive, the dissolved peptide Ac-GCGYGRGDSPG-NH₂ (in same buffer) were added to this solution. The adhesion peptide was allowed to react for 30 minutes at 37° C. Afterwards, the PEG-dithiol precursor was mixed with the above solution and gels were synthesized. The gelation occured within a few minutes, however, the crosslinking reaction was carried out for one hour at 37° C. to guarantee complete reaction.

### Example 3

### Hydrogel Formation by Condensation Reactions

MMP-Sensitive Gels Formed by Condensation Reactions with a Peptide X-Linker Containing Multiple Amines and a Electrophilically Active PEG that Allow Proteolytic Cell Migration

MMP-sensitive hydrogels were also created by conducting a condensation reaction between MMP-sensitive oligopeptide containing two MMP substrates and three Lys (Ac-GKGPQGIAGQKGPQGIAGQKG-NH₂) and a commercially available (Shearwater polymers) difunctional double-ester PEG-N-hydroxysuccinimide (NHS—HBS—CM-PEG-CM-HBA-NHS). In a first step, an adhesion peptides (e.g. the peptide Ac-GCGYGRGDSPG-NH₂) was reacted with a small fraction of NHS—HBS—CM-PEG-CM-HBA-NHS and then this precursor was cross-linked to a network by mixing with the peptide Ac-GKGPQGIAGQKGPQGIAGQKG-NH₂ bearing three □-amines (and one primary amine). In a typical gel preparation for 3-dimensional in vitro studies, both components were dissolved in 10 mM PBS at pH7.4 to give a 10% (w/w) solution and hydrogels were formed within less then one hour.

In contrast to the present hydrogels formed by Michael-type reaction, the desired self-selectivity in this approach is not guaranteed, since amines present in biological materials like cells or tissues will also react with the difunctional activated double esters. This is also true for other PEGs bearing electrophilic functionalities such as PEG-oxycarbonylimidazole (CDI-PEG), or PEG nitrophenyl carbonate.

MMP-Non-Sensitive Hydrogels Formed by Condensation Reactions with a PEG-Amine Cross-Linker And a Electrophilically Active PEG that Allow Non-Proteolytic Cell Migration

Hydrogels were also formed by conducting a condensation reaction between commercially available branched PEG-amines (Jeffamines) and the same difunctional double-ester PEG-N-hydroxysuccinimide (NHS—HBS—CM-PEG-CM-HBA-NHS). In a first step, the adhesion peptides (e.g. the peptide Ac-GCGYGRGDSPG-NH₂) was reacted with a small fraction of NHS—HBS—CM-PEG-CM-HBA-NHS and then this precursor was cross-linked to a network by mixing with the multiarm PEG-amine. In a typical gel preparation for 3-dimensional in vitro studies, both components were dissolved in 10 mM PBS at pH7.4 to give a 10% (w/w) solution and hydrogels were formed within less then one hour.

Again, in contrast to the present hydrogels formed by Michael-type reaction, the desired self-selectivity in this approach is not guaranteed, since amines present in biological materials like cells or tissues will also react with the difunctional activated double esters. This is also true for other PEGs bearing electrophilic functionalities such as PEG-oxycarbonylimidazole (CDI-PEG), or PEG nitrophenyl carbonate.

### Example 4

### Equilibrium Swelling Measurements of Hydrogels Made by Conjugate Addition with Various Macromers and a Thiol-Containing MMP-Sensitive Peptide

Hydrogel structure-function studies were conducted in order to test whether a connection between precursor parameters and network properties could be established and attributed to the well-characterized microstructure of the gels.

Hydrogel Formation and Equilibrium Swelling Measurements

Gels were weighted in air and ethanol before and after swelling and after freeze-drying using a scale with a supplementary density determination kit. Based on Archimedes' buoyancy principle the gel volume after cross-linking and the gel volume after swelling was calculated. Samples were swollen for 24 hours in distilled water. The crosslink density and the molecular weight between cross-links (M_{c}) were calculated based on the model of Flory-Rehner and its modified version by Peppas-Merrill.

PEG Macromer Structure (i.e. m.w. and Number of Arms) Directly Correlates with Swelling Characteristics of the Networks

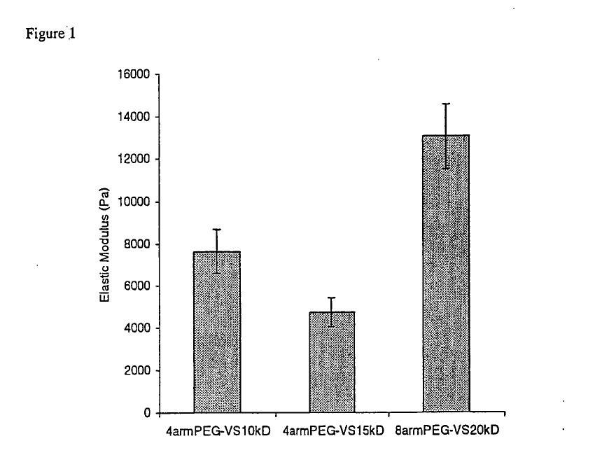

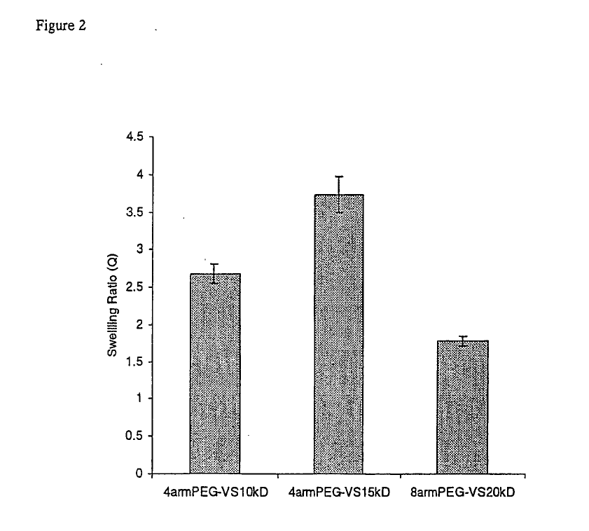

By changing the chain length and number of arms of the macromers at constant precursor concentration (10% w/w), the swelling ratio (and thus the X-link density and molecular weight between X-links) were significantly altered (FIG. 1). The swelling ratio increased with a decrease of the arm length or an increase in fuctionality of the X-linker.

### Example 5

### Viscoelastic Measurements of Hydrogels Made by Conjugate Addition with Various Macromers and a Thiol-Containing MMP-Sensitive Peptide

Dynamic viscoelastic properties of hydrogels were studied performing small strain oscillatory shear experiments using a Bohlin CVO 120 High Resolution rheometer with plate-plate geometry at 37° C. and pH 7.4 under humidified atmosphere between the plates. The PEG-multiacrylate and peptide precursor solutions (30 □l each) were applied to the bottom plate and briefly mixed with a pipette tip. The upper plate (20 mm diameter) was then immediately lowered to a measuring gap size of 0.1 mm. After a short pre-shear period (to ensure mixing of the precursors), the dynamic oscillating measurement was started. The evolution of the storage (G′) and loss (G″) moduli and phase angle (δ) at a constant frequency of 0.5 Hz was recorded. An amplitude sweep was performed in order to confirm that the parameters (frequency and strain) were within the linear viscoelastic regime.

PEG Macromer Structure (i.e. m.w. and Number of Arms) Directly Correlates with Viscoelastic Characteristics of the Networks

By changing the chain length and number of arms of the macromers at constant precursor concentration (e.g. 10% w/w), the shear moduli (G′ and G″) were significantly altered and G′ increased with a decrease of the arm length or an increase in fuctionality of the X-linker again implying that there is a clear correlation between precursor parameters and network properties that can be attributed to the well-characterized microstructure of the gels (FIG. 2).

### Example 6

### Biochemical Degradation by Human MMP-1 of Gels Formed by Conjugate Addition with Peptides Containing Two Cysteine Residues with MMP Substrate Sequences Of Various Enzymatic Activiy in Between

Enzymatic degradation was assessed biochemically by exposure of MMP-sensitive hydrogels to the proteolytic action of activated MMP-1. Hydrogels bearing substrates with three different enzymatic activity were tested (K_{M}/k_{cn}=840%, 100%, 0%). Degradation of hydrogels by MMP-1 was determined by measuring the change of swelling during degradation.

Demonstration of MMP-Degradability and Its Sensitivity to the Enymatic Activty of the Incorporated Oligopeptides

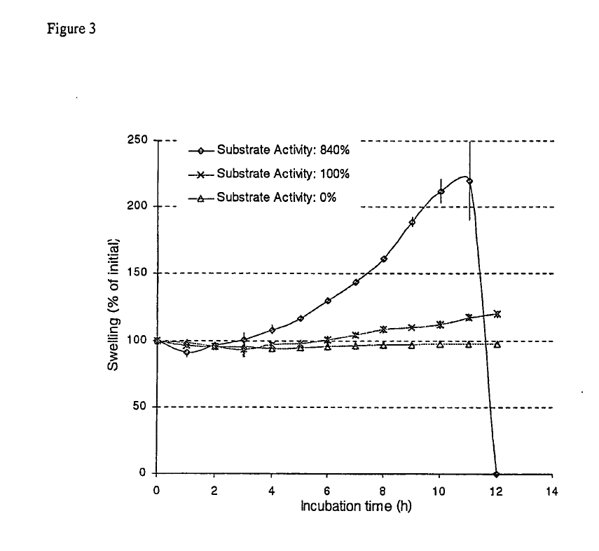

Degradation kinetic (swelling, i.e. weight change) of hydrogels containing MMP-substrates with different activity responded to the amino acid sequence of the protease substrate peptide (i.e. the enzymatic activity). Thus, the kinetics of proteolytic gel breakdown can be engineered by very simple means (FIG. 3).

### Example 7

### Embedding and Culture of hFF-Fibrin Clusters Inside Synthetic PEG-Based Hydrogels to Assess Three-Dimensional Cell Invasion Capacity of the Matrix

Near-confluent cultures of human foreskin fibroblasts (hFFs) were trypsinized, centrifuged and resuspended in 2% (m/v) fibrinogen from human plasma (Fluka, Switzerland) in sterile PBS to a concentration of 30000 cells/μL. To induce gelation of the hFF-fibrinogen suspension, thrombin (Sigma T-6884, Switzerland) and Ca⁺⁺ were added to final concentrations of 2 NIH units/mL and 2.5 mM, respectively, and rapidly mixed with the cell suspension. Prior to gelation, 2 μL droplets of this cell-fibrinogen precursor were gelled on microscope slides for ca. 15 min. at 37° C. The hFF-fibrin clusters were embedded inside 25 μl PEG-based hydrogels by placing three to four clusters into precursor solution prior to gelation. Such hFF-fibrin clusters embedded inside the PEG-based hydrogels were cultured serum-containing DMEM in the 12-well tissue culture plates for up to 30 days. Cell invasion from the cluster into the synthetic gel matrix was imaged and recorded with their center plane in focus. To quantify the penetration depth of the outgrowth, the area of the original hFF-fibrin cluster was measured in the center plane, as was the area of the hFF outgrowth, defined by the tips of the hFF branches in the center plane of focus. These two areas were approximated as circular areas, and their theoretical radii subtracted from each other to give an average hFF outgrowth length.

The fact that cells grow out from the clusters implies that Michael-type addition to conjugated unsaturated groups is self-selective, i.e. acrylates or vinylsulfone react with thiols much faster than with amines that are present on the cell surface. Thus, such materials can be used clinically for example to fill tissue defects by in situ gelation.

### Example 8

### Changing Cell Invasion Rate Into MMP-Sensitive Hydrogels by the Enzymatic Activity of the Incorporated Protease Substrate

Preparation of IMMP-Sensitive Hydrogels with Various MMP Activity

Hydrogels were prepared as follows, with three different MMP-active oligopeptide substrate in the backbone: First, the adhesion peptide Ac-GCGYGRGDSPG-NH₂ was attached pendantly to a 4arm-PEG-vinylsulfone (mol. wt. 15000) at a concentration of 0.1 mM by mixing the PEG precursor (TEOA buffer (0.3M, pH 8.0)) with the adhesion peptide also dissolved in the same buffer. The reaction was allowed to occur for 30 minutes at 37° C. Then, MMP-sensitive peptides of different activity (e.g. Ac-GCRDGPQGIWGQDRCG-NH₂) were mixed with the above solution still possessing Michael-type reactivity and gels were formed around a cell-fibrin clusters according to the method described in example 7. Samples were also cured in parallel and swelling was measured to guarantee that differences in cell migration could be plainly attributed to the change in enzymatic activity (and not differences in network architecture, i.e. X-link densities).

Cell Invasion Rate at a Given Adhesivity and Structure of the Network can be Rationally Tailored by the MMP Activity of the Incorporated Peptide Substrate

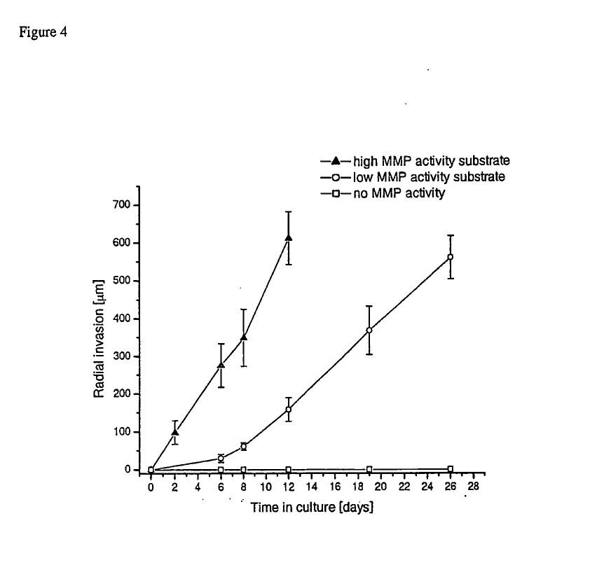

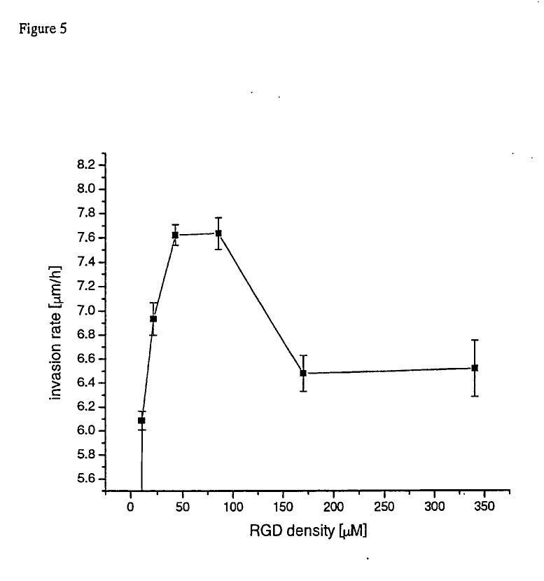

As expected from the biochemical measurements described in example 6, cellular invasion into hydrogels containing MMP-substrates responds to the enzymatic activity of the latter (FIG. 4). Thus, the kinetics of proteolytic gel breakdown can be engineered by very simple means. One synthetic substrate capable of forming a hydrogel by Michael-type addition was identified (GCRDGPQGIWGQDRCG) that degrades significantly faster than the peptide derived from a sequence found in the natural collagen type I (1 □) chain (GCRDGPQGIAGQDRCG). Moreover, a peptide that is not sensitive to cell-secreted MMPs was identified.

### Example 9

### Changing Cell Invasion Rate Into MMP-Sensitive Hydrogels by the Adhesion Site Density

Preparation of MMP-Sensitive Hydrogels with Various Adhesion Site Density

Hydrogels were prepared as follows, with various density of the adhesion peptide Ac-GCGYGRGDSPG-NH₂: First, adhesion peptides at a various concentrations were attached pendantly to a 4arm-PEG-vinylsulfone (mol. wt. 20000) by mixing the PEG precursor (TEOA buffer (0.3M, pH 8.0)) with the adhesion peptide also dissolved in the same buffer. The reaction was allowed to occur for 30 minutes at 37° C. Then, the MMP-sensitive peptide Ac-GCRDGPQGIWGQDRCG-NH₂ was mixed with the above solution still possessing Michael-type reactivity and gels were formed around a cell-fibrin clusters according to the method described in example 7. Samples were also cured in parallel and swelling was measured to guarantee that adhesion site density was constant in all gels after swelling and thus differences in cell migration could be plainly attributed to the change in network architecture.

Cell Invasion Rate at a Given MMP-Sensitivity and Network Architecture can be Rationally Tailored by the Adhesivity of the Network

Three-dimensional cell invasion is mediated by the density of incorporated RGD sites (FIG. 5). HFF invasion rate depends in a biphasic manner on the concentration of adhesion ligands. We found a concentration regime that shows significantly higher migration rates than below or above the particular concentration. Thus, the kinetics of proteolytic gel breakdown can also be engineered by the adhesion site density.

### Example 10

### Changing Cell Infiltration Rate Into MMP-Sensitive Hydrogels by the Molecular Weight (Structure and Number of Arms) of the Employed Macromer

Preparation of MMP-Sensitive Hydrogels with Various Network Architecture

Hydrogels were prepared as follows, with various PEG-VS macromers (4arm20 kD, 4arm15 kD, 4arm10 kD, 8arm20 kD): First, adhesion peptides at a given concentration of 0.1 mM (with regards to the swollen networks!) were attached pendantly to macromers by mixing the PEG precursor (TEOA buffer (0.3M, pH 8.0)) with the adhesion peptide also dissolved in the same buffer. The reaction was allowed to occur for 30 minutes at 37° C. Then, the MMP-sensitive peptide Ac-GCRDGPQGIWGQDRCG-NH₂ was mixed with the above solutions still possessing Michael-type reactivity and gels were formed around cell-fibrin clusters according to the method described in example 7. Samples were also cured in parallel and swelling was measured to guarantee that differences in cell migration could be plainly attributed to the change in adhesivity (and not differences in network architecture, i.e. X-link densities due to the various graft densities with pendant adhesion sites).

Cell Invasion Rate at a Given Adhesivity and MMP-Sensitivity of the Network can be Rationally Tailored by the MMP Activity of the Incorporated Peptide Substrate

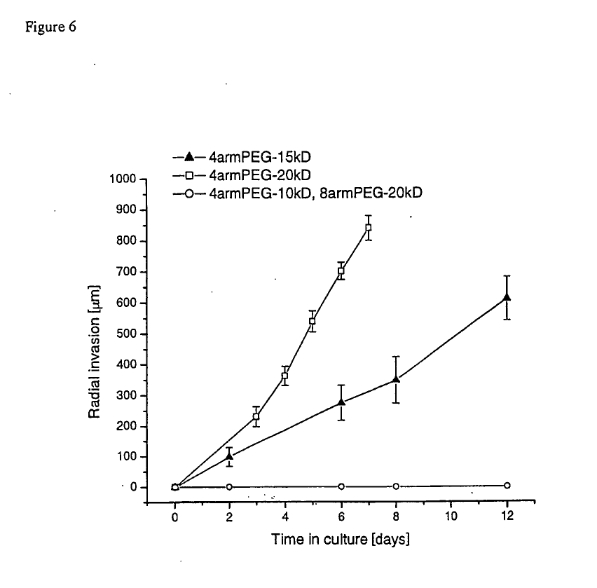

Cell invasion into synthetic gels is also mediated by the network architecture (FIG. 6). HFF invasion rate at constant RGD density and for the same MMP substrate increases with molecular weight. A threshold molecular weight (4armPEG10 kD) was found below which cell invasion essentially ceased. Thus, the kinetics of proteolytic gel breakdown can also be engineered by the network architecture.

### Example 11

### Increasing Cellular Infiltration by Loosening Up the Network Structure for Example Through Creation of Defects, and Switching Cell Migration From a Proteolytic to A Non-Proteolytic Mechanism

Preparation of MMP-Non-Sensitive and Adhesive Hydrogels that Allow Non-Proteolytic Cell Infiltration and Preparation of MMP-Sensitive and Adhesiver Gels that Contain Large Amounts Of Defects (Here: Dangling Ends)

Non-MMP sensitive hydrogels were prepared as follows: First, several known fraction of VS-group of a 4arm PEG-VS 20 kD macromer were reacted at 37° C. for 30 minutes with the amino acid cysteine to “kill” vinylsulfone functionalities prior to network formation in order to create networks with defects (i.e. pendant chains that would not contribute as elastically active chains). Then, the adhesion peptides at a given concentration of 0.1 mM (with regards to the swollen networks!) was attached pendantly to a 4arm PEG-VS 20 kD macromer by mixing the previously modified PEG precursor (TEOA buffer (0.3M, pH 8.0)) with the adhesion peptide also dissolved in the same buffer. The reaction was allowed to occur for 30 minutes at 37° C. Afterwards, this precursor was crosslinked with a PEG-dithiol (m.w.3.4 kD). Swelling of samples were also conducted in parallel to control that differences in cell migration could be plainly attributed to the change in network architecture (i.e. creation of defect that loose up the network).

Similarly, MMP sensitive hydrogels were created with large amounts of defects by first reacting the PEG-VS macromers with the amino acid cysteine to “kill” vinylsulfone functionalities prior to network formation. Functionlization with adhesion sites and cross-linking was performed as described earlier.

Non-Proteolytic Cell Invasion Occurs Within Hydrogels with a Very Loosely X-Linked Network And Cellular Invasion can be Accelerated by Loosening up the Network of MMP-Sensitive Gels

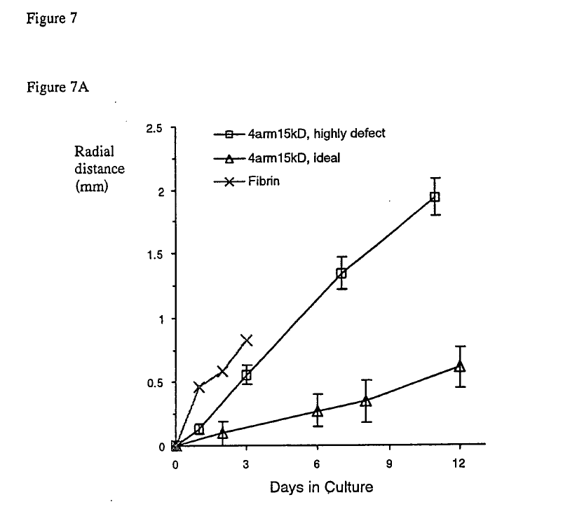

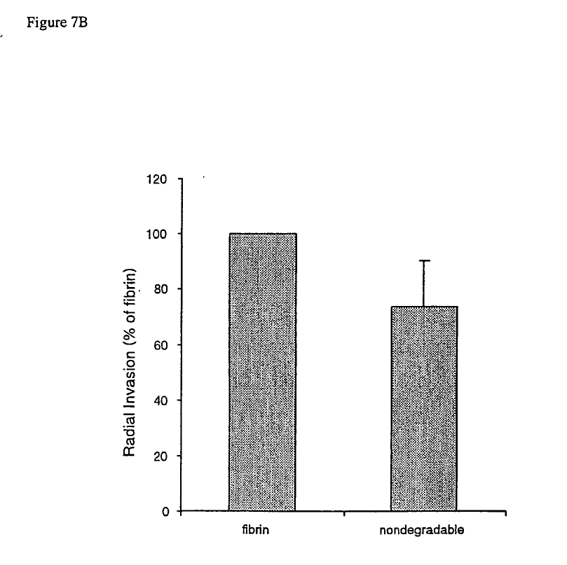

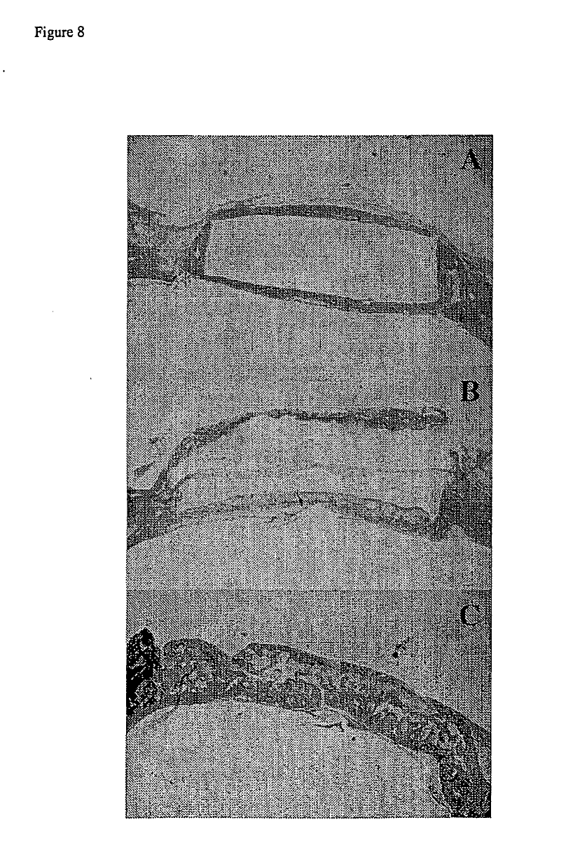

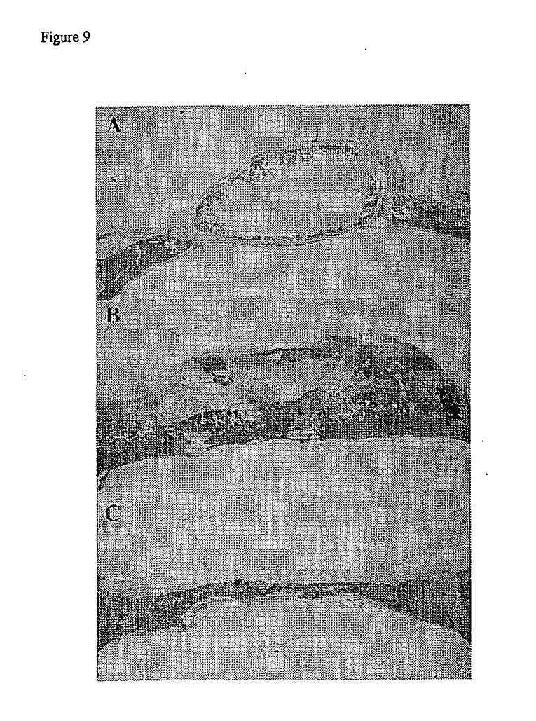

Networks can be created with non-MMP-sensitive molecules that still allow three-dimensional cell invasion to occur (FIG. 7B). However, a very high degree of defects, i.e. a very loosly X-linked network is necessary (G larger than ca. 10). Cell morphology is different from the one in proteolytically degradable matrices. Cells are very thin and spindle-shaped and migrate almost completely straight and radially out of the cluster. Thus, the mechanism of cellular infiltration can be switched from a predominantly proteolytic to a non-proteolytic one. By capping VS-groups with the amino acid Cys prior to cross-linking, MMP-sensitive gels with a very loosely X-linked architecture can be created. Cellular invasin of such matrices is significantly increased compared to the “perfect” networks (7A). In fact, cell invasion rates almost approach the ones of fibrin.

### Example 12

### Hydrogels of 4-Armed PEG-Itaconates 20K

Hydrogels were made with 4-armed PEG (MW 20K) functionalised by itaconates and bifunctional thiols, either in the form of peptides with cysteine residues, e.g. acetyl-GCRDGPQGIWGQDRCG-CONH or as thiol-PEG-thiol, e.g. linear, MW 3.4K.

### Synthesis of 4-Armed PEG-Itaconates

4-hydrogen-1-methyl itaconate (AM 022/6)

102.1 g (0.65 mol) of dimethyl itaconate and 35.0 g (0.18 mol) of toluene-4-sulfonic acid monohydrate are dissolved in 50 ml of water and 250 ml of formic acid in a 1000 ml round bottom flask, equipped with a reflux condenser, a thermometer, and a magnetic stirring bar. The solution is brought to a light reflux by immersing the flask in an oil bath at 120° C. and is stirred for 45 min. Then, the reaction is quenched by pouring the slightly yellow, clear reaction mixture into 300 g of ice while stirring. The resulting clear aqueous solution is transferred to a separation funnel and the product is extracted by washing three times with 200 ml of dichloromethane. The combined organic layers are dried over MgSO, and the solvent is removed by rotary evaporation, yielding 64.5 g of raw product. Extracting the aqueous layer once more with 200 ml of dichloromethane yields another 6.4 g of raw product. A typical acidic smell indicates the presence of some formic acid in the fractions, which is removed by dissolving the combined fractions in 150 ml of dichloromethane and washing twice with 50 ml of saturated aqueous NaCl solution. Drying the organic layer with MgSO, and evaporating the solvent yields 60.1 g of a clear and colorless oil which is distilled under reduced pressure, yielding 55.3 g of a clear and colorless oil. According to ′H NMR analysis the product consists for 91% of 4-hydrogen-1-methyl itaconate, for ca 5% of 1-hydrogen-4-methyl itaconate, and for ca. 4% of dimethyl itaconate.

Gel Formation

Briefly, the precursors solutions were mixed 1:1 in stoichiometric balance of end groups. As was needed for reaction of thiols to vinyl sulfones and acrylates, the presence of triethanolamine in buffer form (TEOA) was required to promote the Michael reaction between thiols and itaconates.

The gel-forming rate of PEG-itaconates was dependent on the amount of base catalyst as well as on the resulting pH of the system. Table 1 presents the time (min) to onset of gelation for 10% PEG-itaconate/PEG-thiol hydrogels with respect to TEOA buffer pH and concentration at room temperature (−23° C.) and 37° C.(incubator/water bath*). Onset of gelation was defined as the point when the liquid precursor solution sticks to pipet tips used to probe the sample.

TABLE 1

| | Base/Buffer | pH | Onset of gelation, min |
|---|---|---|---|
| Room temperature | 0.15 M TEOA | 10.2 | 6 |
| (23° C.) | | 9.5 | 10 |
| | | 9.1 | 17 |
| | | 8.6 | 25 |
| | | 8.4 | >40 |
| | 0.3 M | 9.0 | 8 |
| | | 8.6 | 12.5 |
| | | 8.4 | 30.5 |
| 37° C. | 0.3 M | >9.5 | 3.5 |
| | | 9.0 | <7.5/5 |
| | | 8.6 | 11/9 |
| | | 8.4 | 24/20 |
| | | 8.2 | 45/n.a. |
| | | 7.9 | 48/n.z. |

*note: gelation rates of samples in water bath were in general faster than those in incubator, likely due to better heat transfer for more actual temperature of reaction.

The itaconate-thiol reaction produced hydrogels with characteristics typical of 4-armed 20K PEG gels as formed through reaction of other functionalised end groups, e.g. VS or Ac. Physically, the gels were clear and soft, as previously described for PEG gels formed by reaction of other functionalised groups. In addition, 10% and 20% gels swelled significantly after incubation in saline at 37° C. for 24 hours.

### Cell Culture

PEG-itaconate/peptide hydrogels also supported in vitro cell culture in presence of added RGD peptides.

### Example 13

### Bone Regeneration

Bone Regeneration in the Rat Cranium

Animals were anesthetized by induction and maintenance with Halothan/02. The surgical area was clipped and prepared with iodine for aseptic surgery. A linear incision was made from the nasal bone to the midsagital crest. The soft tissues were reflected and the periosteum was dissected from the site (occipital, frontal, and parietal bones). An eight mm craniotomy defect was created with a trephine in a dental handpiece, carefully avoiding dural perforation. The surgical area was flushed with saline to remove bone debris and a preformed gel was placed within the defect The soft tissues were closed with skin staples. After the operation analgesia was provided by SQ injection of Buprenorphine (0.1 mg/kg). Rats were sacrificed by CO2 asphyxiation 21-35 days after implantation. Craniotomy sites with 5-mm contiguous bone were recovered from the skull and placed in 40% ethanol. At all steps, the surgeon was blinded regarding the treatment of the defects. Samples were sequentially dried: 40% ethanol (2 d), 70% ethanol (3 d), 96% ethanol (3 d), and 100% ethanol (3 d). Dried samples were defatted in xylene (3 d). Defatted samples were saturated (3 d) with methylmethacrylate (MMA, Fluka 64200) and then fixed at 4 ° C. by soaking (3 d) in MMA containing di-benzoylperoxide (20 mg/mL, Fluka 38581). Fixed samples were embedded in MMA, di-benzoylperoxide (30 mg/mL), and 100 μl/mL plastoid N or dibutylthalate (Merck) at 37 ° C. Sections (5 μm) were stained with Toluidine blue 0 and Goldner Trichrome. Histologic slides were scanned and the digital images processed with Leica QWin software.

Bone Healing in the Rat Cranium Defect Model can be Tailored by Several Matrix Characteristics

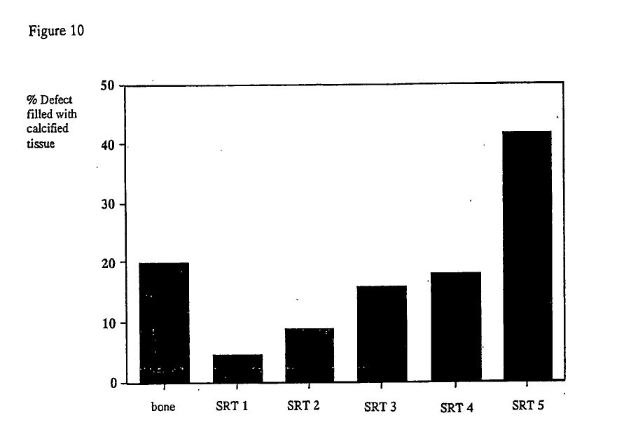

Synthetic hydrogels were used to induce de novo bone formation in vivo. Histological preparations indicated that the healing response largely depended on the composition of the hydrogel matrix. At a dose of 5 μg BMP-2 per implant MMP-sensitive peptides containing a fast degrading substrate, Ac-GCRDGPQGIWGQDRCG, and adhesive hydrogels were infiltrated by cells, predominantly fibroblast-like cells and intramembranous bone formation was observed (FIG. 10, C). By 5 wk, implant materials were fully resorbed, and new bone covered the defect area. Here, complete bridging of the defects was observed. Control materials made with a MMP-insensitive PEG-(SH)2 (FIG. 10, A) showed no cell infiltration and only bone formation around the intact gel implants. The slower degrading oligopeptide Ac-GCRDGPQGIAGQDRCG lead to significantly less cell infiltation (FIG. 10, B). Thus, the healing response in vivo was dependend on the enzymatic activiy of the incorporated substrate.

Gels with different structure were tested, including MMP-sensitive degradable gels made with 4armPEG-VS 15 kD, MMP-sensitive gels made with 4armPEG-VS-20 kD 20K and hydrolytically degradable gels made with PEG-dithiol 3.4 kD and 4armPEG-Acrylate In each animal we saw complete bridging of the defects at this early timepoint but distinct morphology differences. The slower degrading gel showed less cell infiltration and more remaining matrix while the fastest degrading gel showed newly formed bone with morphology similar to original bone.

Bone Healing in the 8-mm Sheep Drill Defect Model

8 mm drill defects were created in the tibia and femur of sheep and various synthetic matrices were polymerized in situ in the presence of 20 μg/mL of rhBMP-2 to test the ability of these matrices to induce healing of a boney defect. We proposed that it is crucial for a wound healing matrix to have strong cell infiltration characteristics, meaning cells can readily enter and remodel the synthetic matrix. As described earlier, we have shown in vitro and in other in vivo models that the details of the matrix, incorporating degradation sites, the composition of the matrix and the density of the matrix as examples, are crucial for functional cell infiltration. Within the development process outlined above, a series of materials with different cell infiltration characteristics were developed. Within this extensive series, five materials were tested in the sheep, representing a range of cell migration properties. These materials were labeled SRT 1-5, with SRT1 having the lowest cell infiltration characteristics. The amount of infiltration then increases through the series leading to SRT5 which allows the greatest amount of cell infiltration into the matrix. The animals were then allowed to heal for 8 weeks and were subsequently sacrificed and the defect region was excised for analysis via micro computerized topography (ACT) as well as histological analysis.

Bone Healing in the 8-mm Sheep Drill Defect Model can be Tailored by Several Matrix Characteristics

The five materials that were tested explored two different changes in the composition. SRT1 is a hydrogel with a plasmin degradation site incorporated into the backbone while SRT2 is a hydrogel with identical structure but with a collagenase degradation site in the backbone. These gels are made by mixing a peptide that each respective enzyme can cleave which is bracketed by two thiols (cysteines) which is then crosslinked with RGD modified 4arm15K peg vinyl sulfone. It can be seen that by changing the specificity of the enzyme that can degrade the gel, a different healing response is observed with the collagenase degradable sequence performing better. Additionally, the effect of structural aspects were expored as well. SRT2, SRT3 and SRT4 represent gels with decreasing crosslink density and it can be seen that the rate of healing is increased as the crosslink density decreases. SRT3 is made from a trithiol peptide and a linear pegvinylsulfone while SRT4 is identical to SRT2 except that it has a 4arm20K peg instead of a 4arm15K peg, leading to lower crosslink density. This clearly will have a limit as a minimum crosslink density will be required to obtain gellation. Finally, SRT5 is a hydrolytically degradable matrix made from 4arm 15K Pegacrylate and 3.4K peg dithiol. These gels have the fastest degradation time and as such have the highest healing rate.

In analyzing these results, it is vital to consider where the implants were located. These implants were placed within cancellous bone and as such, the entire volume of the bone is not filled with calcified tissue. When normal cancellous bone is analyzed via μCT, the bone volume fraction is approximately 20%. When μCT was employed to test the results of the various synthetic matierals tested in the assay, newly formed calcified bone was found within the original defect. In some examples, the amount of bone was very substantial for the dose employed, leading to approximately 20% calcified volume as well. There was also a clear trend in the healing response with respect to the cell infiltration characteristics of the gels employed. Gels which gave limited ability for cells to infiltrate showed the lowest healing response, with newly formed calicfied tissue only appearing at the margins of the defect and no calcified tissue at all in the center. In contrast, the materials that had faster cell infiltration properties showed a much higher healing response with a direct correlation between faster cell infiltration and better bone healing being observed.

These results were further confirmed by histology. When the histological sections were analyzed, it was observed that the boneless void in the center of “SRT1” actually represents gel that had not degraded at all. In each sample of the series, gel was observed, however materials with faster cell infiltration properties showed less remaining gel and more bone and precursor bone within the center of the defect. This clearly demonstrates that the bone was formed by infiltration of the surrounding cells into the matrix and subsequent conversion and formation of bone and bone matrix. In some examples, where the infiltration of cells into the matrix is slow, it is possible to block and inhibit regeneration. However, when a matrix is employed that has fast cell infiltration properties, then the amount of bone healing is dramatically enhanced leading to a excellent healing response.

Influence of Starting Concentration of First Precursor Molecule in the Healing Response in a Sheep Drill Hole Model

Two different starting concentrations of the enzymatic degradeable gels were employed. In each of these, the concentration of RGD and the active factor (CplPTH at 100 μg/mL) were kept constant The polymeric network was formed from a four-arm branched PEG functionalized with four vinylsulfone endgroups of a molecular weight of 20 kD (molecular weight of each of the arms 5 kD) and dithiol peptide of the following sequence Gly-Cys-Arg-Asp-(Gly-Pro-Gln-Gly-Ile-Trp-Gly-Gln)-Asp-Arg-Cys-Gly. Both precursor components were dissolved in 0.3 M Triethanolamine. The starting concentration of the functionalized PEG (first precursor molecule) and the dithiol peptide (second precursor molecule) were varied. In one case the concentration was 12.6 weight % of the total weight of the composition (first and second precursor component+triethanolamine). The 12.6 weight % corresponds to a 10 weight % solution when calculated on bases of only the first precursor component (100 mg/mL first precursor molecule). The second staring concentration was 9.5 weight % of the total weight of the composition (first and second precursor component+triethanolamine) which corresponds to 7.5 weight % on basis of only the first precursor molecule (75 mg/mL first precursor molecule) of total weight. This has the consequence that the amount of dithiol peptide was changed such that the molar ratio between vinyl sulfones and thiols was maintained.

The gel which started from a starting concentration of 12.6 weight % swelled to a concentration of 8.9 weight % of total weight of the polymeric network plus water, thus the matrix had a water content of 91.1. The gel which started from a starting concentration of 9.5 weight % swelled to a final concentration of 7.4 weight % of total weight of the polymeric network plus water, thus had a water content of 92.6.

In order to explore the effect of this change, these materials were tested in the sheep drill defect. Here, a 750 μL defect was placed in the cancellous bone of the diaphyses of the sheep femur and humerus and filled with an in situ gellating enzymatic gel. The following amount of calcified tissue was obtained, determined via μCT, with each group at N=2:

| Starting concentration of gel | Calcified Tissue |
|---|---|
| 12.6% | 2.7% |
| 9.5% | 38.4% |

By making the gels less dense and easier for cell penetration, the resulting healing response with the addition of an active factor was stronger. The effect of having final solid concentrations of below 8.5 weight % is obvious from these results.

Clearly then, the design of the matrix is crucial to enable healing in wound defects. Each of these hydrogels were composed of large chains of polyethylene glycol, endlinked to create a matrix. However, the details of how they were linked, via enzymatic degradation sites, the density of the linkers and several other variables were crucial to enable a functional healing response. These differences were very clearly observed in the sheep drill defect model.

1. A kit for forming a polymeric network, comprising a first and a second precursor molecule in a predefined ratio and a base solution, wherein the first precursor molecule comprises a trifunctional branched molecule comprising three arms substantially similar in molecular weight, the second precursor molecule comprises a bifunctional molecule and the ratio of equivalent weight of the functional groups of the first and second precursor molecule is in a range of between 0.9 and 1.1, wherein the sum of the first and second precursor molecule is in a range of between 8 and 12 weight %, preferably 9 to 10 weight % of the total weight of the first and second precursor molecule and the base solution, molecular weight of the arms of the first precursor molecule, the molecular weight of the second precursor molecule and functionality of the branching points are selected such that the water content of the polymeric network is between the equilibrium weight % and 92 weight % of the total weight of the polymeric network after completion of water uptake.

2. The kit according to claim 1 wherein the functional groups are located at the termini of the first and second precursor molecule.

3. The kit according to claim 1 wherein the first precursor molecule is a three arm polymer comprising a functional group at the end of each arm and having a molecular weight of 15 kD and the second precursor molecule is a bifunctional linear molecule wherein the molecular weight of the second precursor molecule is in the range of between 0.5 to 1.5 kD.

4. The kit according to claim 1 wherein the first precursor molecule is a four arm polymer comprising a functional group at the end of each arm and having a molecular weight of 20 kD and the second precursor molecule is a bifunctional linear molecule wherein the molecular weight of the second precursor molecule is in the range of between 1 to 3 kD, preferably between 1.5 and 2 kD.

5. The kit according to claim 1 wherein the functional groups of the first precursor molecule are electrophilic groups and the functional groups of the second precursor molecule are nucleophilic groups.

6. The kit according to claim 1 wherein the functional groups of the first precursor molecule are nucleophilic groups and the functional groups of the second precursor molecule are electrophilic groups.

7. The kit according to claim 5 wherein the electrophilic groups are conjugated unsaturated groups or conjugated unsaturated bonds selected from the group consisting of acrylates, vinylsulfones, methacrylates, acrylamides, methacrylamides, acrylonitriles, vinylsulfones, 2- or 4-vinylpyridinium, maleimides and quinones.

8. The kit according to claim 7 wherein the electrophilic groups are selected from the group consisting of —CO2N(COCH₂)₂, —CO2H, CHO, —CHOCH₂, —N═C═O, N(COCH)₂, —S—S—(C₅H₄N).

9. The kit according to claim 5 wherein the nucleopholic groups are selected from the group consisting of amino-, thiol- and hydroxyl-groups.

10. The kit for forming a polymeric network by free radical reactions according to claim 1 wherein the functional groups of the first and second precursor molecules comprise unsaturated bonds, preferably conjugated unsaturated bonds.

11. The kit according to claim 1 wherein the first and second precursor molecule are selected from the group consisting of proteins, peptides, polyoxyalkylenes, poly(vinyl alcohol), poly(ethylene-co-vinyal alcohol), poly(acrylic acid), poly(ethylene-co-acrylic acid), poly(ethyloxazoline), poly(vinyl pyrrolidone), poly(ethylene-co-vinyl pyrrolidone), poly(maleic acid), poly(ethylene-co-maleic acid), poly(acrylamide), and poly(ethylene oxide)-co-poly(propylene oxide) block copolymers.

12. The kit according to claim 1 wherein the first precursor molecule is a polyethylene glycol comprising as functional groups vinyl sulfone or acrylate groups and the second precursor molecule is polyethylene glycol comprising as functional groups thiol- or amine groups.

13. The kit according to claim 1 wherein the first precursor molecule is a polyethylene glycol comprising vinylsulfone groups and the second precursor molecule is peptide comprising thiol groups wherein the peptide is a substrate for metalloproteinases.

14. The kit according to claim 1 further comprising cell adhesion peptides covalently bound to biomaterial.

15. The kit according to claim 14, wherein the cell adhesion peptides are selected from the group consisting of RGD sequence of fibronectin,— and the YIGSR sequence from laminin.

16. The kit according to claim 1 further comprising growth factors or growth factor like peptides.

17. The kit of parts according to claim 16 wherein the growth factors or growth factor like peptides are selected from the group consisting of TGF, β, BMP, IGF, PDGF, human growth releasing factor, and PTH.

18. A composition suitable for forming a polymeric network, comprising a first and second precursor molecule in a predefined ratio and a base solution,
wherein the first precursor molecule is at least comprises a trifunctional branched molecule comprising at least three arms substantially similar in molecular weight, and
wherein the second precursor molecule is at least comprises a bifunctional molecule and the ratio of equivalent weight of the functional groups of the first and second precursor molecule is in a range of between 0.9 and 1.1 l ₂
wherein the sum of the first and second precursor molecule is in a range of between 8 to 12 weight %, preferably 9 to 10 weight % of the total weight of the first and second precursor molecule and the base solution, and
wherein the molecular weight of the arms of the first precursor molecule, the molecular weight of the second precursor molecule and the functionality of the branching points are selected such that the water content of the polymeric network is between the equilibrium weight % and 92 weight % of the total weight of the polymeric network after completion of water uptake.

19. The composition according to claim 18 wherein the functional groups are located at the termini of the first and second precursor molecule.

20. The composition according to claim 18 wherein the first precursor molecule is a three arm polymer comprising a functional group at the end of each arm and having a molecular weight of 15 kD and the second precursor molecule is a bifunctional linear molecule wherein the molecular weight of the second precursor component is in the range of between 0.5 to 1.5 kD.

21. The composition according to claim 18 wherein the first precursor molecule is a four arm polymer comprising a functional group at the end of each arm and having a molecular weight of 20 kD and the second precursor molecule is a bifunctional linear molecule wherein the molecular weight of the second precursor molecule is in the range of between 1 to 3 kD.

22. The composition according to claim 18 wherein the functional groups of the first precursor molecule are electrophilic groups and the functional groups of the second precursor molecule are nucleophilic groups.

23. The composition according to claim 18 wherein the functional groups of the first precursor molecule are nucleophilic groups and the functional groups of the second precursor molecule are electrophilic groups.

24. The composition according to claim 22 wherein the electrophilic groups are conjugated unsaturated groups or conjugated unsaturated bonds selected from the group consisting of acrylates, vinylsulfones, methacrylates, acrylamides, methacrylamides, acrylonitriles, vinylsulfones, 2- or 4-vinylpyridinium, maleimides, and quinones.

25. The composition according to claim 24 wherein the electrophilic groups are selected from the group consisting of —CO₂N(COCH₂)₂, —CO₂H, —CHO, —CHOCH₂, —N═C═O, —N(COCH)₂, and —S—S—(C₅H₄N).

26. The composition according to claim 22 wherein the nucleophilic groups are selected from the group consisting of amino-, thiol- and hydroxyl-groups.

27. The composition according to claim 18 for forming a polymeric network by free radical reactions wherein the functional groups of the first and second precursor molecules comprise unsaturated bonds.

28. The composition according to claim 18 wherein the first and second precursor molecule are selected from the group consisting of proteins, peptides, polyoxyalkylenes, poly(vinyl alcohol), poly(ethylene-co-vinyl alcohol), poly(acrylic acid), poly(ethylene-co-acrylic acid), poly(ethyloxazoline), poly(vinyl pyrrolidone), poly(ethylene-co-vinyl pyrrolidone) poly(maleic acid), poly(ethylene-co-maleic acid), poly(acrylamide), of and poly(ethylene oxide)-co-poly(propylene oxide) block copolymers.

29. The composition according to claim 18 wherein the first precursor molecule is a polyethylene glycol comprising as functional groups vinyl sulfone or acrylate groups and the second precursor molecule is polyethylene glycol comprising as functional groups thiol- or amine groups.

30. The composition according to claim 18 wherein the first precursor molecule is a polyethylene glycol comprising vinylsulfone groups and the second precursor molecule is peptide comprising thiol groups wherein the peptide is a substrate for metalloproteinases.

31. The composition according to claim 18 further comprising cell adhesion peptides covalently bound to the biomaterial.

32. The composition according to claim 31, wherein the cell adhesion peptides are selected from the group consisting of RGD sequence of fibronectin; and the YIGSR sequence from laminin.

33. The composition according to claim 18 further comprising growth factors or growth factors like peptides.

34. The composition according to claim 33 wherein the growth factors or growth factor like peptides are selected from the group consisting of TGF β, BMP, IGF, PDGF, human growth releasing factors and PTH.

35. A biomaterial formable by a composition comprising a first and second precursor molecule in a predefined ratio and a base solution,
wherein the first precursor molecule comprises a trifunctional branched molecule comprising three arms substantially similar in molecular weight,
wherein the second precursor molecule comprises a bifunctional molecule and the ratio of equivalent weight of the functional groups of the first and second precursor molecule is in a range of between 0.9 and 1.1,
wherein the sum of the first and second precursor molecule is in a range of between 8 to 12 weight % of the total weight of the first and second precursor molecule and the base solution,
wherein the composition is suitable for forming a polymeric network, and
wherein the molecular weight of the arms of the first precursor molecule, the molecular weight of the second precursor molecule and the functionality of the branching points are selected such that the water content of the polymeric network is between the equilibrium weight % and 92 weight % of the total weight of the polymeric network after completion of water uptake.

36. A method for wound healing comprising administering to a site in need of treatment a composition comprising a first and second precursor molecule in a predefined ratio and a base solution,
wherein the first precursor molecule comprises a trifunctional branched molecule comprising three arms substantially similar in molecular weight,
wherein the second precursor molecule comprising a bifunctional molecule, and wherein the ratio of equivalent weight of the functional groups of the first and second precursor molecule is in a range of between 0.9 and 1.1,
wherein the sum of the first and second precursor molecule is in a range of between 8 to 12 weight % of the total weight of the first and second precursor molecule and the base solution,
wherein the composition is suitable for forming a polymeric network, and
wherein the molecular weight of the arms of the first precursor molecule, the molecular weight of the second precursor molecule and the functionality of the branching points are selected such that the water content of the polymeric network is between the equilibrium weight % and 92 weight % of the total weight of the polymeric network after completion of water uptake.
